(19) United States
(12) Patent Application Publication
(10) Pub. No.: US 2022/0356583 A1
(43) Pub. Date: Nov. 10, 2022

(54) POST-TREATMENT VIA ULTRASONIC CONSOLIDATION OF SPRAY COATINGS

(71) Applicant: The Government of the United States of America, as represented by the Secretary of the Navy, Arlington, VA (US)

(72) Inventors: Robert F. Brown, Summerland Key, FL (US); Gregory M. Smith, Alexandria, VA (US)

(21) Appl. No.: 17/242,445

(22) Filed: Apr. 28, 2021

(51) Int. Cl. C23C 24/04; B05D 3/00; B05D 3/12; C23C 4/02; C23C 4/06; C23C 4/123; C23C 28/02

(52) U.S. Cl. CPC C23C 24/04; B05D 3/007; B05D 3/12; B05D 3/002; C23C 4/02; C23C 4/06; C23C 4/123; C23C 28/021

(57) ABSTRACT

Methods are provided for a post-treatment process for use with coatings deposited via thermal spray and/or cold spray to modify the microstructures of the coatings and improve associated cohesion and adhesion properties. Such process includes performing ultrasonic consolidation of the spray coating as a post-treatment step after deposition of the spray coating onto a substrate. A system for spray deposition and ultrasonic consolidation is also provided.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; techtran@nrl.navy.mil, referencing Navy Case Number 113069-US1.

### BACKGROUND

Thermal spray and cold spray deposition are material deposition techniques that enable powdered feedstock material to be heated or melted, accelerated towards a target, and eventually deposited in layers to build a coating. One set of thermal spray processes includes high velocity oxygen fuel spraying and having been developed in the 1980s, these processes are relatively matured. Cold spray is more recent, being developed in the 1990s, with accelerated development in the early 2000s.

One of the longstanding challenges with thermal spray and cold spray is the ability to control microstructures of the resulting coatings. Because of the lower processing temperatures, it is particularly difficult to form dense coatings with cold spray. This is especially true for harder materials that do not readily deform upon impact. A range of post-treatments and solutions have been proposed to combat this problem. However, these solutions are fraught with their own issues. For example, hot isostatic pressing is a post-treatment process that reduces the porosity and densifies the coating, but does not improve adhesion properties. Weld repair is another post-treatment process that has a distortion penalty and cannot be adequately completed in the overhead orientation. Heat treatments may improve structure and adhesion, but many materials are not suitable due to their composition or size.

### SUMMARY

This Summary is intended to introduce, in simplified form, a selection of concepts that are further described in the Detailed Description. This Summary is not intended to identify key or essential features of the claimed subject matter, nor is it intended to be used as an aid in determining the scope of the claimed subject matter. Instead, it is merely presented as a brief overview of the subject matter described and claimed herein.

Embodiments described herein are directed to a cold spray or thermal spray post-treatment process for use with inorganic coatings to modify their microstructures and improve adhesive and cohesive bonding without thermal distortion. The post-treatment process includes ultrasonic consolidation that may be performed after deposition of all layers of a coating or in an iterative manner after deposition of one or multiple layers with growing layer deposition.

An embodiment is directed to a method for cold spray deposition and post-treatment. The method includes preparing a substrate for a cold spray deposition and depositing a first layer of cold spray coating on the substrate. Ultrasonic consolidation is performed on the first layer as a post-treatment step.

Another embodiment is directed to a method for thermal spray deposition and post-treatment. The method includes preparing a substrate for thermal spray deposition and depositing a first layer of thermal spray coating on the substrate. Ultrasonic consolidation is performed on the first layer as a post-treatment step.

Yet another embodiment is directed to a system for coating deposition and ultrasonic consolidation. The system includes a sonotrode comprising a horn configured to apply force and vibrational energy on a deposited layer of material and a nozzle configured to deposit the layer of material via thermal spray, cold spray, or similar.

### BRIEF DESCRIPTION OF THE DRAWINGS

FIG. 1 depicts a flowchart for a method for a post-treatment process for use with a cold spray and/or thermal spray process, according to an example embodiment.

FIG. 2 is a diagram of a system for spray deposition and ultrasonic consolidation, is according to an example embodiment.

FIG. 3 depicts a surface with a Stellite blend spray coating.

FIG. 4 depicts a cross section of the Stellite blend spray coating of FIG. 3.

FIG. 5 depicts a surface with a Stellite blend spray coating after ultrasonic consolidation.

FIG. 6 depicts a cross section of the Stellite blend spray coating of FIG. 5.

FIG. 7 depicts a surface with a Cu-38Ni blend spray coating.

FIG. 8 depicts a cross section of the Cu-38Ni blend spray coating of FIG. 7.

FIG. 9 depicts a surface with a Cu-38Ni blend spray coating after ultrasonic consolidation.

FIG. 10 depicts a cross section of the Cu-38Ni blend spray coating of FIG. 9.

FIG. 11 depicts a cross section of a CuNi-38 blend spray coating.

FIG. 12 depicts a cross section of the CuNi-38 blend spray coating of FIG. 11 after ultrasonic consolidation at 9000 N load applied at 80 in/min traverse and 36 μm amplitude.

FIG. 13 depicts a cross section of a CuNi-38 blend spray coating, with structure revalued after a FeCl₃ etch.

FIG. 14 depicts a cross section of the CuNi-38 blend spray coating of FIG. 13 after ultrasonic consolidation at 9000 N load applied at 40 in/min traverse and 34 μm amplitude, with structure revalued after a FeCl₃ etch.

FIG. 15 depicts a cross section of a Cu-38Ni blend spray coating.

FIG. 16 depicts a cross section of the Cu-38Ni blend spray coating of FIG. 15 after ultrasonic consolidation at 9000 N load applied at 60 in/min traverse and 34 μm amplitude.

FIG. 17 depicts a cross section of a Stellite blend spray coating.

FIG. 18 depicts a cross section of the Stellite blend spray coating of FIG. 17 after ultrasonic consolidation at 9000 N load applied at 80 in/min traverse and 44 μm amplitude.

FIG. 19 depicts a cross section of a Cu-38Ni blend spray coating.

FIG. 20 depicts a cross section of the Cu-38Ni blend spray coating of FIG. 19 after ultrasonic consolidation at 9000 N load applied at 80 in/min traverse and 36 μm amplitude.

FIG. 21 depicts a cross section of a Stellite blend spray coating.

FIG. 22 depicts a cross section of the Cu-38Ni blend spray coating of FIG. 21 after ultrasonic consolidation at 9000 N load applied at 80 in/min traverse and 46 μm amplitude.

### DETAILED DESCRIPTION

### Definitions

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, it is submitted that it is within the knowledge of one skilled in the art to effect such feature, structure, or characteristic in connection with other embodiments whether or not explicitly described.

In describing and claiming the disclosed embodiments, the following terminology will be used in accordance with the definition set forth below.

As used herein, the singular forms “a,” “an,” “the,” and “said” do not preclude plural referents, unless the content clearly dictates otherwise.

As used herein, the term “and/or” includes any and all combinations of one or more of the associated listed items.

As used herein, the term “about” or “approximately” when used in conjunction with a stated numerical value or range denotes somewhat more or somewhat less than the stated value or range, to within a range of ±10% of that stated.

Terminology used herein should not be construed as being “means-plus-function” language unless the term “means” is expressly used in association therewith.

### Overview

Deposition of inorganic coatings, especially via cold spray processing, does not always have sufficient deposition energy to flatten or deform upon impact to form dense coatings. Moreover, hand-held and/or portable repair methods that are currently used may be limited in developing adequate mechanical properties and therefore post-treatment or post-processing techniques are required to improve coating quality.

The ultrasonic consolidation technique described herein enables follow-up processing that transforms the coating into a denser final state, optimized for various applications. The ultrasonic consolidation technique may be used with cold spray or thermal spray to modify the coating microstructure and improve the associated cohesion and adhesion properties for improving adhesion and tensile behavior. The coating microstructure and enhanced mechanical properties may be achieved through application of pressure and high frequency at low amplitudes with the ultrasonic consolidation technique. The ultrasonic consolidation post-treatment may be performed after deposition of one or multiple coating layers in an iterative manner or after deposition of all layers of the coating.

The application of the ultrasonic consolidation post-treatment allows for in-situ repair in multiple orientations. Thus, the ultrasonic consolidation technique offers an effective alternative to traditional weld-repair techniques without the associated distortion or cracking penalty. The advantages of the ultrasonic consolidation technique include forming a densified coating with improved mechanical properties, including adhesion and cohesion properties (e.g., coating density, adhesion strength and interfacial bonding, yield strength, ductility, etc.), and the possible applicability to a wide range of materials that are readily available and suitable for spray deposition and/or ultrasonic consolidation processes.

### Example Embodiments

Cold spray is a solid-state powder deposition technique that involves accelerating powder feedstock particles, typically 10-100 μm in size, through a converging/diverging nozzle with a compressible carrier gas, such as helium, nitrogen, or air, to achieve supersonic gas velocities for favorable deposition. Such a nozzle may be a de Laval nozzle, which is a tube that has an internal asymmetric hourglass shape designed to convert heat energy of the flow into kinetic energy. The carrier gas, at an established pressure and temperature, enters the nozzle's convergence section and compresses the gas at subsonic velocity through its length unit it reaches the constriction or throat. The particle velocity is relatively slow at this location, compared to the gas velocity, and continues to absorb heat from the carrier gas. As the gas exits the throat and enters the diverging section of the nozzle, pressure and temperature reduce, while velocities increases to near or supersonic velocities. Particles accelerate in the gas stream from the end of the throat to nozzle exit, where compressible gas velocities, V_{g}, follow equation 1:

$${V}_{g} = M \sqrt{γ RT} \qquad ( equation 1 )$$

where R is the specific gas constant, T is the temperature, γ is the specific heat ratio (e.g., 1.4 for diatomic nitrogen, and 1.66 for monatomic helium), and M is the Mach number. Gas velocities may also be influenced by aspects of the nozzle throat as follows.

$$\frac{A}{{A}^{*}} = \frac{1}{M} {( [ \frac{2}{γ + 1} ] [ 1 + ( \frac{γ - 1}{2} ) {M}^{2} ] )}^{( γ + 1 ) / [ 2 ( γ - 1 ) ]} \qquad ( equation 2 )$$

where A is the calculated cross-sectional area along the nozzle, and A* is the area of the nozzle throat. Employing gas stream velocities, pressures, and temperatures, the particle velocity (Vₚ) may be modeled based on the estimated particle drag coefficient (C_{d}), mass of the particle (m), gas velocity (V_{g}), cross sectional area of a particle (Aₚ), and the assumption that the particle velocity is much less than the gas velocity, as follows.

$${V}_{p} = {V}_{g} \sqrt{\frac{{C}_{d} {A}_{p} {ρ}_{g}}{m}} \qquad ( equation 3 )$$

where ρ_{g} is the gas density. Particle drag is dependent on particle density, size and shape, where the larger or the more irregular the shape, drag increases and particle velocity or kinetic energy decreases. This aspect is important, especially when carrier gas temperatures and pressures are low, such as for portable cold spray systems. Additionally, the particle temperature is subsequently lower than its melting point upon exit from the nozzle, thus resulting in limited oxide formation, in contrast to inflight particles of many thermal spray processes. This is a desirable aspect of cold spray, where the feedstock properties are retained during deposition and particle exit velocities can range from 500-1200 m/s. The basis of particle velocity and momentum create the relatively high kinetic energy, coupled with the cold spray fluid mechanics, which is the driving force for the critical velocity window of deposition, determine coating adhesion, cohesion, and deposit compaction and efficiency. The solid-state particle undergoes deformation and adiabatic shear instability as it impacts and craters into the substrate, which consequently results in substrate deformation, improving first layer adhesion.

High-pressure cold spray and low-pressure cold spray are two types of cold spray processes. High-pressure cold spray uses nitrogen, helium, or air at pressures, generally at pressures of 1 MPa or greater and/or flow rates greater than 2 m³/min. Low-pressure cold spray uses the similar carrier gas as high-pressure cold spray, but at lower pressures (e.g., below 1 MPa) and/or lower flow rates (e.g., below 2 m³/min).

Feedstock materials for cold spray include pure metals (e.g., aluminum, nickel, copper, or titanium), metal alloys, polymers, and hybrid materials (e.g., metal-metal, metal-alloy, metal-ceramic, or metal-graphene/carbon nanotubes). These materials allow for the application of different coatings, for example, to repair a component with similar or improved materials or to form desired features into the cold spray coatings deposited on a substrate or a target surface of the component. Modifying or repairing a component may be a more economical choice than replacing that component. The cold spray process may be a useful alternative for brush plating, electroplating, weld repairs, etc., because it is a quick process and can build material reliably in a relatively short time.

The advantages of cold spray include materials being deposited at lower temperatures than their melting points and no melting in the process, e.g. deposition in solid-state, limiting particle or substrate thermal distortion or oxidation. Because of the focused particle spray path, there is little preparation that is required of the substrate area (e.g., minimal masking of the area, no heat-affected zone). The waste materials (non-deposited powders) may be recycled, while repairing of parts saves energy, time to procure new parts, and resources. In addition, portable cold spray system and/or equipment allows cold spray to be used for parts where removal for repair is otherwise difficult or not feasible.

Thermal spray is another coating deposition process. The difference between thermal spray and cold spray is that thermal spray generally comprises of molten or semi-molten droplets of feedstock material that are then sprayed onto a substrate. Thermal spray covers a wide range of sub-processes, which vary by mode of deposition, types of materials, and in application. Generally either powder or wire feedstock materials are used and may be chemically or electrically heated to promote softening or melting of the feedstock prior to deposition. Feedstock material for thermal spray includes metals, refractory materials, ceramics, cermets, composites, and polymers, essentially anything that melts or softens during the heating process, with a large degree of process control, depending on the process and material selection.

Bonding in thermal spray tends to be mechanical in nature, rather than metallurgical, although high temperature processes and higher impact velocities can show some degree of metallurgical bonding. Thus, the substrate surface must generally be clean and/or roughened before spraying. Large temperature gradients can also be induced because of the large transfer of thermal energy from the molten or partially molten particles to the target surface during the deposition process. Rapid quenching results when these particles impact which can induce varying degrees of residual stresses.

Several types of thermal spray exist, including air plasma spray (APS), wire arc, flame or high velocity oxygen fuel (HVOF) spray. The plasma spraying process uses an electric arc to form a high-temperature, thermal plasma jet through dissociating and ionizing the argon and supplementary hydrogen or helium process gases, to subsequently heat and melt the feedstock material. Plasma temperatures in the immediate vicinity of the arc can be greater than 10,000 K. The feedstock material is then fed into the thermal plasma by an inert gas of nitrogen or similar, and propelled towards a target surface. The electric arc or twin-wire arc spraying processes also use electrical means to heat the coating material via a direct electrical arc between one or two feedstock wire material sources to cause them to melt. Compressed air or inert gas may atomize melt product and propel the molten droplets towards the substrate to form a coating. The flame spraying process uses a combustion chemical means of heating. A fuel source, such as propane or acetylene, is combusted with oxygen, to heat the feedstock material in wire or powder form. Combustion product, compressed air, or inert gas then propels the molten product towards the substrate to form a coating. The HVOF spraying process also uses chemical heat. The heat and pressure generated from combusting a liquid or gas fuel is mixed with oxygen or compressed air. The feedstock particles are heated and expand in a combustion chamber or introduced into the gas stream, which flows through a de Laval nozzle, forcing the exhaust gases and feedstock particles out at supersonic speeds towards the substrate. The HVOF process is notable because of the high deposition velocities, which can range be 400 m/s and above, in line with cold spray deposition. Whereas other thermal spray processes can induce a degree of particle oxidation during the period between heating and impact on a target substrate, HVOF process can reduce the propensity for oxidation due to the small particle dwell times and rapid deposition times.

Both thermal spray and cold spray deposition processes can yield a range of microstructural, physical, and electro-chemical properties. However, especially in targeting dense, high strength coatings for metal repairs and structurally integrated coatings, as-sprayed properties can be limited. Thus, to improve the quality of a cold spray coating or a thermal spray coating, a post treatment may be necessary.

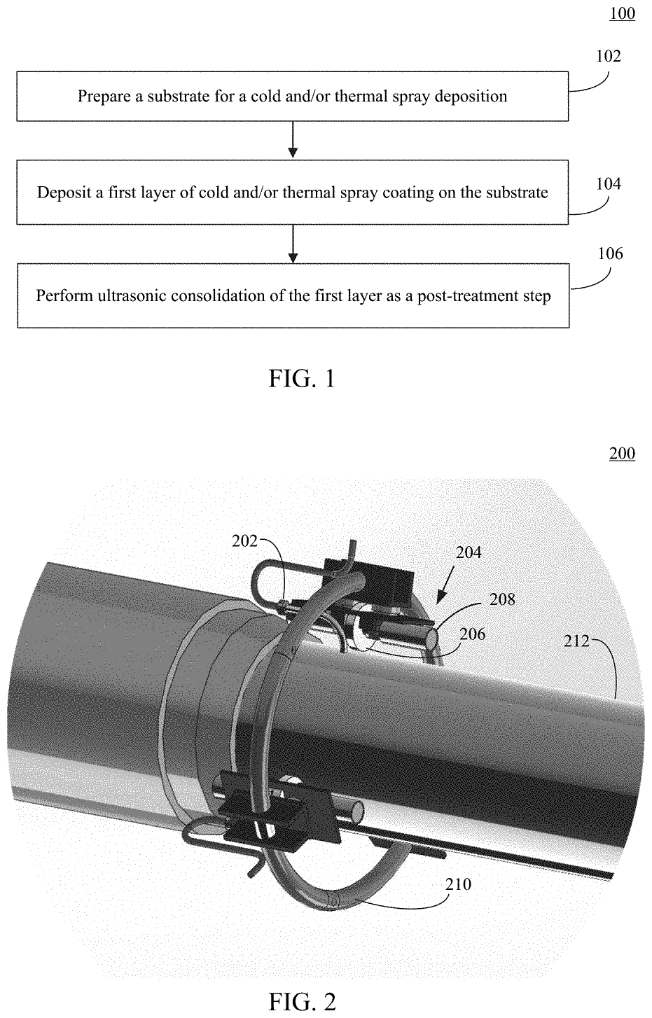

FIG. 1 depicts a flowchart 100 for a method for a post-treatment process for use with a cold spray or thermal spray process, according to an example embodiment. Flowchart 100 begins with step 102, in which a substrate is prepared for a cold and/or thermal spray deposition. Such a substrate may be any surface to be repaired, enhanced, or modified in some way, including a surface that has been coated. For example, the substrate may be a surface of a piece of field equipment, rotating components (e.g., shafts, rollers, etc.), hydraulic parts, engines, turbines, cavities, or medical devices to be repaired, enhanced, or manufactured. As another example, in an additive manufacturing application, a substrate and/or component may be formed with the cold spray or thermal spray process on a bed. A smaller component and/or substrate may be contained within a booth or a computer numerical control space where it may be manipulated (e.g., during the deposition or post-treatment process). Preparation of the substrate includes any of cleaning the substrate, pre-machining the substrate, removing oxidation from the substrate, texturing or creating profile on the substrate via abrasive blasting, tooling, or grinding. In an embodiment, such preparation makes the substrate more suitable for cold and/or thermal spray deposition and to provide adequate adhesion between the coating and the substrate. For example, abrasive blasting may be used to create a texture on the substrate to enable the sprayed material to bond to the substrate.

In step 104, a cold and/or thermal spray coating is deposited on the substrate. For example, the coating may be deposited using any of the cold spray processes (e.g., high-pressure cold spray or low-pressure cold spray) or thermal spray processes (e.g., plasma, arc, flame or HVOF spray). Coatings may be applied in varying thickness (e.g., 0.1 to 1 millimeter or greater) depending on the application (e.g., deposition, surface repair, additive manufacturing) and/or feedstock material comprised of individual layers of variable thickness. The physical and mechanical properties of the coating may vary with the thickness of the coating. The thickness may be controlled by the number passes of spraying the nozzle over the substrate, with each pass forming a layer of the coating.

In step 106, ultrasonic consolidation of the cold and/or thermal spray coating is performed as a post-treatment step. Ultrasonic consolidation is a process by which force and vibrational energy is applied to the cold and/or thermal spray coating to generate a densified coating, potentially modifying the mechanical properties of the coating and/or substrate. Example mechanical properties include adhesion strength and interfacial bonding, cohesion, coating density, composite (coating and substrate) yield strength and coating yield strength, hardness, and ductility. Thus, the post-treatment step improves the quality of the coating, by providing downward force (weight and rolling action) on the coating along with vibration at a particular frequency—oscillating between one direction and an opposite direction to agitate the coating. In addition, the post-treatment step may change properties of the coating. For example, ultrasonic consolidation may modify an adhesion property or the bonding quality between the substrate and the spray coating. As another example, ultrasonic consolidation may modify a cohesion property or the bonding quality between different layers of the coating. The degree of compaction of the coating depends on the material(s) involved, speed of the applied force from the sonotrode horn (e.g., slow or fast), amplitude (e.g., how far left and right the sonotrode vibrates during the ultrasonic consolidation process), the number of repeated activity (“hits”) on the substrate. In an embodiment, the ultrasonic consolidation process may remove surface disparities to generate a smoother top surface as well as a more compact coating, which may induce localized compressive stresses and locally reduce crack nucleation sites.

Ultrasonic consolidation may be performed once at the end of the deposition of all layers of the coating. That is, after the entire coating has been sprayed to a desired thickness. Alternatively, ultrasonic consolidation may be performed in an iterative manner that includes performing an ultrasonic consolidation post-treatment step after each deposition step or multiple deposition steps. For example, ultrasonic consolidation may be performed via a layer-by-layer manner where ultrasonic consolidation follows each deposition step or multiple deposition steps, with each deposition step forming one layer of the final coating. Depending on the application and feedstock material used, it may be preferred to perform the ultrasonic consolidation post treatment once at the completion of the coating deposition. For example, when a spray deposition is used to form a protective coating suitable for marine or industrial application, using bronze, stainless steel, zinc, aluminum, tantalum, etc., the coating may be relatively thin, which does not need more than one post-treatment step. In other cases, it may be better to add layers via thermal spray or cold spray incrementally and performing ultrasonic consolidation after each layer is added or after a few layers are added. For example, when a substrate is being sprayed with the intent of shaping desired features onto the coating, it may be better to perform ultrasonic consolidation after one layer or a few layers are deposited to achieve the desired structural and/or bonding quality of the coating, thereby engineering the coating for the desired final application. Thus, the ultrasonic consolidation process and material selection may provide a large matrix of coating/substrate combinations to produce a coating with desired mechanical properties (e.g., hard and brittle or soft with elongation).

In between the deposition step(s) and/or post-treatment step(s), it may be necessary or useful to wait for a time period or to perform other steps such preparing the substrate for subsequent steps (e.g., depositing more layers of the coating or consolidating those layers). Thus, in embodiments, steps 102, 104 and 106 may each be repeated as needed, and not necessarily in that order, with or without any pause in time. For example, for a coating that has been thermal sprayed and remains very hot in temperature, it may be necessary to wait for that coating to be sufficiently cooled before performing ultrasonic consolidation. The appropriate range of temperature and/or time may depend on the material involved as well as the limitations of the equipment used. In an embodiment, one type of material may be used for one or more layers of the coating. In another embodiment, more than one types of material may be used for the coating, either mixed together and then sprayed or in a layer-by-layer manner with one material being used for one layer and then another material being used for another layer of the coating.

For either the cold spray or thermal spray process, there may be controllable parameters that may be selected by the system designer and/or user, such as vibration amplitude, normal force (i.e., rolling motion), sonotrode travel speed, baseplate temperature, etc. In addition, there may be fixed parameters that are based on the properties of the tool and/or material used, for example, vibrational frequency (e.g., 20 kHz), sonotrode roughness (e.g., 7-14 microns), material type and properties (e.g., steel, tape/foil thickness).

In addition, flowchart 100 may include other steps not shown in FIG. 1. For example, in some embodiments, after the deposition step, the spray coating may be machined to reduce roughness and generate a smooth, flush surface. In other embodiments, a final preparation of the coating and/or the repaired surface may be performed after the ultrasonic consolidation post-treatment.

The thermal and/or cold spray deposition process and ultrasonic consolidation process described in flowchart 100 may be performed separately, using different equipment, or together using an integrated system that combines the two processes. One such system is depicted in FIG. 2, although the method of FIG. 1 is not so limited to that implementation.

FIG. 2 is a diagram of a system 200 for spray deposition and ultrasonic consolidation, according to an example embodiment. In embodiments, the method of FIG. 1, as described above or variations thereof may be implemented with system 200. Other structural and operation embodiments will be apparent to persons skilled in the relevant art(s) based on the following.

System 200 includes a spray nozzle 202 and ultrasonic consolidation sonotrode 204 with horn 206 and transducer 208 mounted on a rod. Nozzle 202 and sonotrode 204 are mounted on a ring 210 and are configured to operate on a component/substrate, such as shaft 212. In an embodiment, nozzle 202 and sonotrode 204 are mounted on a movable plate, and thus may move together as a unit. Other components not shown in FIG. 2 may be included in system 200, such as a powder feeder, gas heater or a cooling jacket, etc.

Nozzle 202 may be configured for a cold spray and/or thermal spray process. For example, nozzle 202 may be implemented with a de Laval nozzle that includes a barrel with constriction and subsequent expansion to the opening of the nozzle and with various configuration or orientation. Nozzle 202 can be a straight nozzle or include a bend or radius to change the direction of gas/powder flow. Nozzle 202 is configured to accelerate deposition gas and entrapped feedstock particles and to spray them onto a substrate via an opening. In an embodiment, nozzle 202 may be mounted on a 4-5 axis motion system or robotic arm such that the build process is not limited to successive horizontal layers or parallel planes. In another embodiment, more than one material may be deposited simultaneously via multiple nozzles to achieve graded coatings or parts.

Sonotrode 204 may be configured to create and apply force and vibrational energy on a substrate that has been sprayed with a coating to densify that coating. The force may be applied in a downward/normal direction on the coating, and the vibrational energy may be applied in a suitable direction for the system/application, e.g., horizontal or lateral. Sonotrode 204 may include one or more piezoelectric transducers (e.g., transducer 208) attached to a rod. Also attached to the rod is a horn (e.g., horn 206), configured to apply force to the coating. An alternating current oscillating at ultrasonic frequency may be applied by a power supply unit to the transducers, causing them to expand and contract, vibrating back and forth along the rod. The transducers may be configured to be vibrating in different direction, such as horizontally or vertically. In an embodiment, the ultrasonic frequency may be in the range of 20 kHz to 70 kHz with small vibrational amplitudes, such as from 13 to 130 micrometers. Sonotrode 204 may be formed of various materials, such as titanium, aluminum, or steel and can have various shapes (e.g., round, square, with teeth or profiled) and sizes. Thus, the material(s) and shape of the sonotrode may be customized for the desired application. In embodiments, multiple horns having different sizes may be attached to the rod, each horn being more suitable to one application than another. For example, a smaller horn may be suitable for smaller applications or parts and a larger horn may be more appropriate for larger parts/substrate. In embodiments, the horn may be modular and/or removable such that it may be removed and/or replaced with a newer or more appropriate horn for a particular application. In such embodiments, the components of system 200 may be calibrated (e.g., tuning the horn to the output of the transducers), individually or in combination, to optimize operation of system 200.

As shown in FIG. 2, more than one nozzle and sonotrode may be mounted on ring 210, although in embodiments, one nozzle and one sonotrode may be adequate and configured for planar use. Spray nozzle 202 and sonotrode 204 may be mounted on ring 210 configured to rotate around shaft 212 to provide three-dimensional coverage for the spraying process as well as the ultrasonic consolidation process.

The configuration of nozzle 202 and sonotrode 204 is not intended to be limited to what is depicted in FIG. 2. In FIG. 2, the part to be treated is a shaft, but other substrate types and geometries may be possible, with other configurations of nozzle(s) and sonotrode(s). In an embodiment, system 200 may be used for a layer-by-layer iterative process of spraying and ultrasonic consolidation of the sprayed coating on a round shaft. However, system 200 may be adapted for other substrate/part geometries, such as flat plate and curved/angle/valve seat, with other nozzle/sonotrode configurations. Such configurations may include one or more of curved, straight, or cooled nozzles, as well as single or multiple nozzles and/or sonotrodes. In an embodiment, for a flat surface, a single nozzle and sonotrode may suffice, especially for small areas. In another embodiment, a 6+axis robot or an x-y stage may be used for deposition and/or ultrasonic consolidation while the component is on a turntable or other manipulation. In yet another embodiment, system 200 may have other types of control, such as x-y-z control via a computer numerical control mount, configured in a manner to allow for a cold/thermal spray nozzle to move in one direction and for the sonotrode to move in the same direction, following the nozzle. In embodiments, system 200 may be implemented as a fixed system or a portable system.

### Additional Embodiments

The processes described herein have been tested and the results analyzed. In a limited scope trial, two types of alloy materials were used, a copper-nickel alloy (Cu-38Ni) blended with CrC-30NiCr and a cobalt-chromium alloy (Co-30Cr-5W), also known as Stellite-6B, also blended with a CrC-30NiCr material to enhance deposition. Examination of top surface and coating cross sectional microstructures show evidence of coating densification. The table below includes some parameters of the trial.

| Variable | Definition | Range |
|---|---|---|
| Frequency | Vibrational frequency | 10-20 kHz |
| Amplitude | X/Y direction movement, | 30 to 50 μm |
| | based on applied voltage as | |
| | a percent of total supplied, | |
| | applied at the above | |
| | frequency | |
| Applied force | Downward pressure (force | 3,000 to 9,0000 N |
| | applied to the sonotrode | |
| | horn) | |
| Traverse speed | Movement of the horn | 40 to 80 in/min |
| | across the sample | |
| Number of “hits” | Repeated activity on the | 1 to 3 repeats |
| | sample area | |

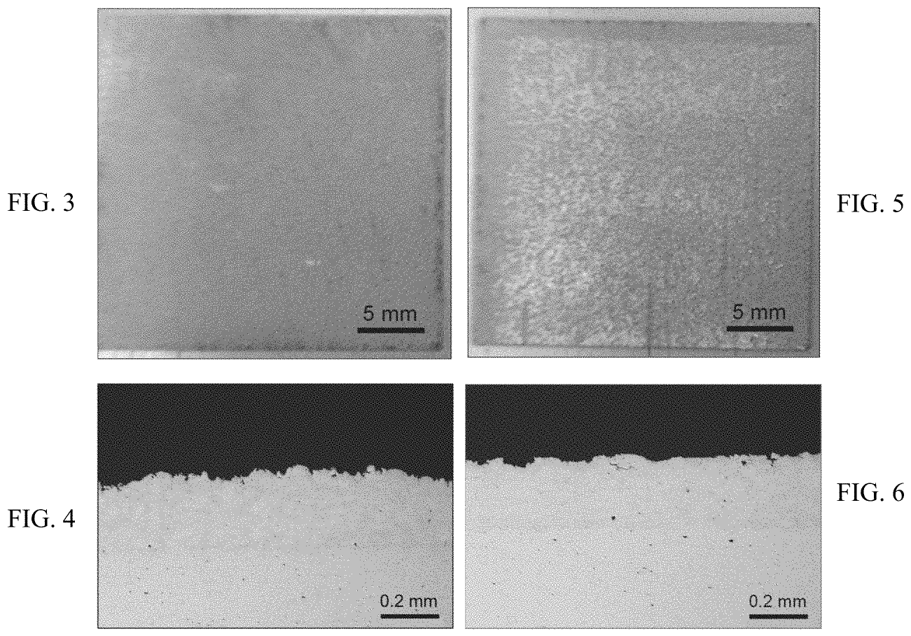

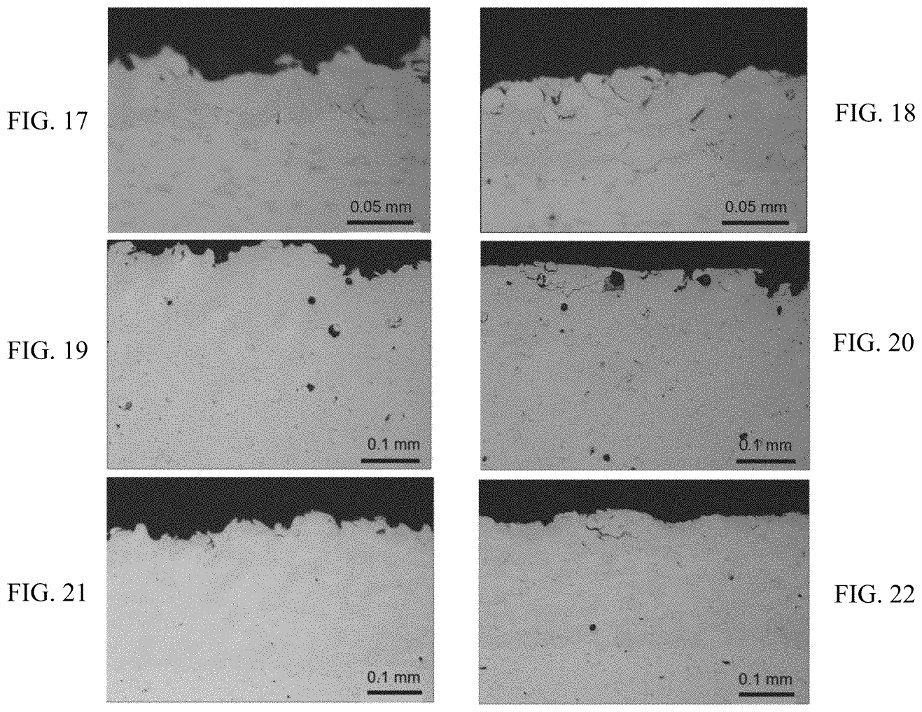

Some results of the trial are depicted in FIGS. 3-22. FIG. 3 depicts a surface with spray coating. This is a control cold spray coating that has not undergone post-treatment. FIG. 4 depicts a cross section of the coating of FIG. 3. As seen in FIG. 4, the top surface of the coating is rough with disparities at the top and micropores within the coating. FIG. 5 depicts a surface with a spray coating that has ultrasonic consolidation performed on it as a post-treatment. As seen in FIG. 5, the ultrasonic consolidation treated surface appears smoother and more polished than the surface of FIG. 3. FIG. 6 depicts a cross section of the spray coating of FIG. 5. The cross section of FIG. 6 appears smoother at the top surface compared to the cross section of FIG. 4. This is because the downward force applied by the sonotrode essentially leveled down the high points on the top surface to generate a smoother surface and a more compact coating, which can also induce localized compressive stresses and locally reduce crack nucleation sites.

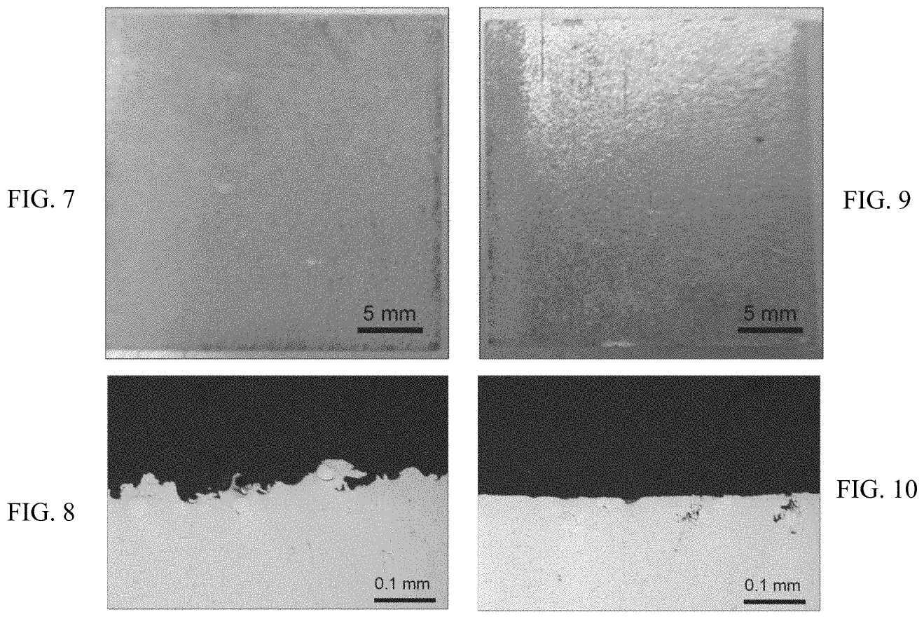

FIG. 7 depicts a surface with a spray coating that is different from the spray coating of FIG. 3. FIG. 8 depicts a cross section of the spray coating of FIG. 7. FIG. 9 depicts a surface with a spray coating that has ultrasonic consolidation performed on it as post-treatment. FIG. 10 depicts a cross section of the spray coating of FIG. 9.

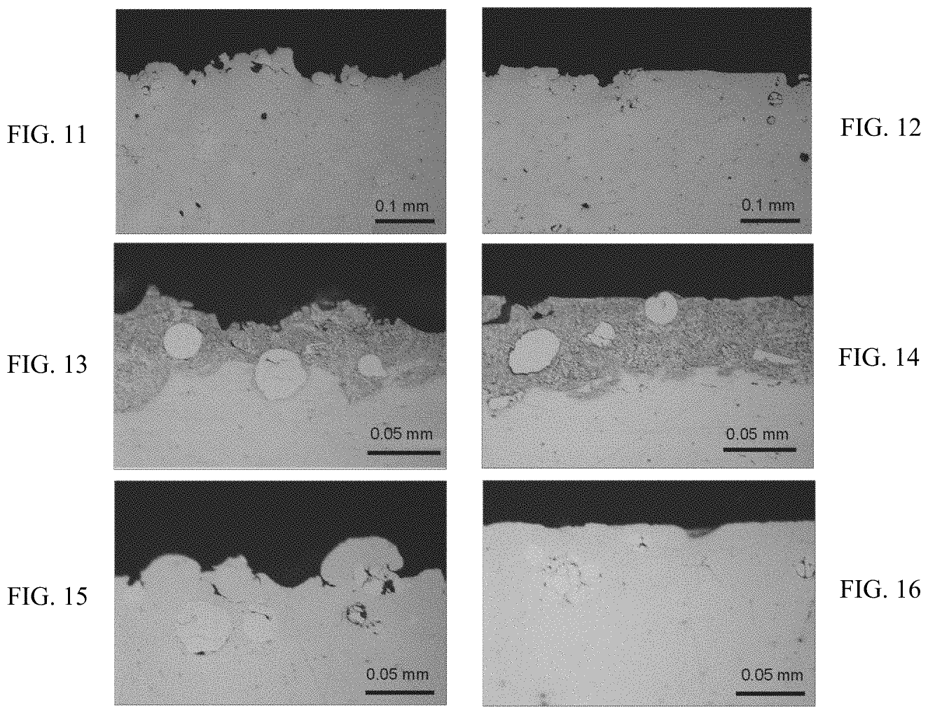

FIGS. 11, 13, 15, 17, 19 and 21 each depicts a cross section of a spray coating without post-treatment. FIGS. 12, 14, 16, 18, 20, and 22 each depicts the spray coating of FIGS. 11, 13, 15, 17, 19 and21, respectively, after ultrasonic consolidation is performed on the spray coatings as a post-treatment.

### CONCLUSION

While various embodiments of the disclosed subject matter have been described above, it should be understood that they have been presented by way of example only, and not limitation. Various modifications and variations are possible without departing from the spirit and scope of the embodiments as defined in the appended claims. Accordingly, the breadth and scope of the disclosed subject matter should not be limited by any of the above-described exemplary embodiments, but should be defined only in accordance with the following claims and their equivalents.

1. A method for cold spray deposition and post-treatment, comprising:
preparing a substrate for a cold spray deposition;
depositing a first layer of cold spray coating on the substrate, the coating comprising a hybrid material; and
performing ultrasonic consolidation of the first layer as a post-treatment step.

2. The method of claim 1, wherein the preparing the substrate comprises at least one of:
pre-machining the substrate;
texturing or creating profile on the substrate via abrasive blasting, tooling, or grinding;
cleaning the substrate; or
removing oxidation from the substrate.

3. The method of claim 1, further comprising depositing a second layer of cold spray coating on top of the first layer.

4. The method of claim 3, further comprising performing ultrasonic consolidation of the first layer and the second layer in an iterative manner that includes performing an ultrasonic consolidation post-treatment step after one or more cold spray deposition steps.

5. The method of claim 3, further comprising performing ultrasonic consolidation of the first layer and the second layer after both layers have been deposited.

6. The method of claim 3, wherein the performing ultrasonic consolidation modifies a cohesion property between the first layer and the second layer.

7. The method of claim 1, wherein the performing ultrasonic consolidation modifies an adhesion property between the substrate and the first layer.

8. The method of claim 1, wherein the performing ultrasonic consolidation comprises applying force and vibration energy to the first layer to generate a densified coating with associated changes to mechanical properties of the first layer.

9. A method for thermal spray deposition and post-treatment, comprising:
preparing a substrate for a thermal spray deposition;
depositing a plurality of layers of thermal spray coating on the substrate; and
performing ultrasonic consolidation on the plurality of layers as a post-treatment step.

10. The method of claim 9, wherein the preparing the substrate comprises at least one of:
pre-machining the substrate;
texturing or creating profile on the substrate via abrasive blasting, tooling, or grinding;
cleaning the substrate; or
removing oxidation from the substrate.

11-13. (canceled)

14. The method of claim 9, wherein the performing ultrasonic consolidation modifies a cohesion property between the plurality of layers.

15. The method of claim 9, wherein the performing ultrasonic consolidation modifies an adhesion property between the substrate and a layer of the plurality of layers that is proximate to the substrate.

16. The method of claim 9, wherein the performing ultrasonic consolidation comprises applying force and vibrational energy to the plurality of layers to generate a densified coating with associated changes to mechanical properties of the plurality of layers.

17. A system for coating deposition and ultrasonic consolidation, comprising:
a sonotrode comprising a horn configured to apply force and vibrational energy on a deposited layer of material; and
a nozzle configured to deposit the layer of material via spraying.

18. The system of claim 17, wherein the nozzle is configured for use with a cold spray process.

19. The system of claim 17, wherein the nozzle is configured for use with a thermal spray process.

20. The system of claim 17, wherein the horn is further configured to be removable from the sonotrode.

21. The method of claim 1, wherein the hybrid material comprises a metal-metal, metal-alloy, metal-ceramic, metal-graphene or carbon nanotube material.
